(19) United States
(12) Patent Application Publication
(10) Pub. No.: US 2008/0294725 A1
(43) Pub. Date: Nov. 27, 2008

(54) METHOD AND SYSTEM FOR SUPPORTING SIMULATED-EXERCISE IN CYBER SPACE USING MESSAGE

(76) Inventors: Eun Young KIM, Daejeon (KR); Byung-Chul BAE, Daejeon (KR); Young-Tae YUN, Daejeon (KR); Eung-Ki PARK, Daejeon (KR)

Correspondence Address: LADAS & PARRY LLP, 224 SOUTH MICHIGAN AVENUE, SUITE 1600, CHICAGO, IL, 60604, US

(21) Appl. No.: 11/955,821

(22) Filed: Dec. 13, 2007

(30) Foreign Application Priority Data
May 22, 2007 (KR) 10-2007-0049508

(51) Int. Cl. G06F 15/16

(52) U.S. Cl. 709/205

(57) ABSTRACT

Provided are a method and system for supporting a simulated-exercise in a cyber space using a message. The system for supporting a simulated-exercise using a massage includes a simulated-exercise manager system for training trainees in a remote location connected through a network by transmitting a situation message for informing critical situations to the trainees and an automatic response message.

### BACKGROUND OF THE INVENTION

1. Field of the Invention

The present invention relates to a method and system for supporting a simulated-exercise in a cyber space using a message, and more particularly, to a simulated-exercise method and system for evaluating the appropriateness of countermeasure by setting up an imaginary critical situation in a message and checking proper countermeasures for each threatening stage by easily creating critical situations of threatening stages in a message based exercise.

2. Description of the Related Art

The present invention relates to vulnerability analysis. A vulnerability analysis tool identifies threats that allow an illegal user to access an information system, threats that disturb an information system to provide a normal service, and threats that drain, modify, and delete valuable data in an information system. A vulnerability analysis system determines whether corresponding security vulnerabilities exist in an information system or not and analyzes the security level of the information system based on the determination result.

Nessus is one of representative tools employing vulnerability analysis technology (refers to www.nessus.org). The Nessus is a security vulnerability scanner, free software, for detecting the vulnerabilities in a local or a remote computer. The Nessus was developed by Renaud Derasion. That is, Renaud Derasion introduced the Nessus on April 1998. Recently, version 3.0.5 of Nessus was introduced on January 2007. The Nessus examines the vulnerability in plug-in manner. Lately, the Nessus provides about 13,603 libraries.

However, it is impossible to simulate a serious critical situation using the Nessus tool because some of simulated serious critical situations may seriously influence a real network and a real system.

### SUMMARY OF THE INVENTION

Accordingly, the present invention is directed to a method and system for supporting a simulated-exercise in a cyber space using a message, which substantially obviates one or more problems due to limitations and disadvantages of the related art.

It is an object of the present invention to provide a method and system for supporting a simulated-exercise using messages that are constituted for creating and transmitting a message using a threatening message and for analyzing a user's countermeasure.

It is another object of the present invention to provide a method and system for supporting a simulated-exercise using a message, which evaluates the countermeasure of a user for a critical situation through a message by providing real-time user states of receiving and returning corresponding messages based on an imaginary critical situation message which is artificially created by a manager.

It is a further another object of the present invention to provide a method and system for supporting a simulated-exercise using messages that are constituted for enabling the creation of a serious critical situation and for examining proper countermeasures of each stage without seriously influencing a system by easily creating critical situations of each threatening stages.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, there is provided a system for supporting a simulated-exercise using a massage, including a simulated-exercise manager system for training trainees in a remote location connected through a network by transmitting a situation message for informing critical situations to the trainees and an automatic response message.

In another aspect of the present invention, there is provided a method for supporting a simulated-exercise using a message of a simulated-exercise manager system including a simulated-exercise scenario composing module, a user automatic response generation module, a simulated-exercise situation generation module, a simulated-exercise situation display module, and a simulated-exercise information database, including the steps of: at the simulated-exercise scenario composing module, receiving a situation message and an auto response message; at the simulated-exercise scenario composing module, receiving exercise group information for assigning an exercise group and exercise group classification information for assigning characteristics of each selected exercise group; transmitting a situation message, an automatic response message corresponding to the situation message, user group information, and user group classification information to the simulated-exercise situation displaying module; and storing a situation message, an automatic response message corresponding to the situation message, user group information, and user group classification information in the simulated-exercise database.

The method may further include the steps of: a) storing a situation message, an auto response message, user group information, and user group classification information in a simulated-exercise database; b) at a user automatic response generation module in the simulated-exercise manager system, searching the situation message from the simulated-exercise information database and receiving an automatic response message corresponding to the situation message; c) at a simulated-exercise situation generation module in the simulated-exercise manager system, receiving a situation message from the simulated-exercise information database and transmitting the received situation message to a trainee; d) receiving automatic response information corresponding to the transmitted situation message from a trainee; and e) at a simulated-exercise situation display module of the simulated-exercise manager system, displaying a simulated-exercise situation message, an automatic response message, exercise group information, and user automatic response information, which are stored in the simulated-exercise information database.

The step c) may include the steps of: at the simulated-exercise situation generation module, determining whether or not user group information is included in the simulated-exercise information database for generating a simulated-exercise; selecting an exercise group according to exercise group information if the simulated-exercise situation generation module determines that the exercise group information is included in the simulated-exercise information database; at the simulated-exercise situation generation module, transmitting a situation message in the simulated-exercise information database to the exercise group selected through the user automatic responder; at the simulated-exercise situation generation module, providing simulated-exercise generation information to the simulated-exercise situation display module; and at the simulated-exercise situation generation module, storing simulated-exercise generation information in a database.

The method may further include the steps of: at the simulated-exercise situation display module, receiving and displaying a situation message, an automatic response message, and group information from a simulated-exercise scenario composing module; at the simulated-exercise situation display module, receiving and displaying user automatic response information from the user automatic response generation module; and at the simulated-exercise situation display module, receiving and displaying simulated-exercise generation information from the simulated-exercise situation generation module.

The method may further include the steps of, after the step c): at the user automatic responder, receiving a exercise situation message having critical situation information from the simulated-exercise manager system through a network; at the user automatic responder, transmitting a simulated-exercise situation message and an automatic response message to a trainee, and receiving user automatic response information as a response of the automatic response message; and at the user automatic responder, transmitting the received user automatic response information to the simulated-exercise manager system.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention, are incorporated in and constitute a part of this application, illustrate embodiments of the invention and together with the description serve to explain the principle of the invention. In the drawings:

FIG. 1 is a block diagram illustrating a system for supporting a simulated-exercise using a message according to an embodiment of the present invention.

FIG. 2 is a flowchart illustrating a method for supporting a simulated-exercise using a message according to an embodiment of the present invention.

FIG. 3 is a flowchart illustrating the operations of a scenario composing module according to an embodiment of the present invention.

FIG. 4 is a flowchart illustrating the operations of a user automatic response generator module according to an embodiment of the present invention.

FIG. 5 is a flowchart illustrating the operations of a simulated-exercise situation generation module according to an embodiment of the present invention.

FIG. 6 is a flowchart illustrating the operations of a simulated-exercise situation display module according to an embodiment of the present invention.

FIG. 7 is a flowchart illustrating the operations of a user automatic responder for exercise according to an embodiment of the present invention.

### DETAILED DESCRIPTION OF THE INVENTION

Reference will now be made in detail to the preferred embodiments of the present invention, examples of which are illustrated in the accompanying drawings.

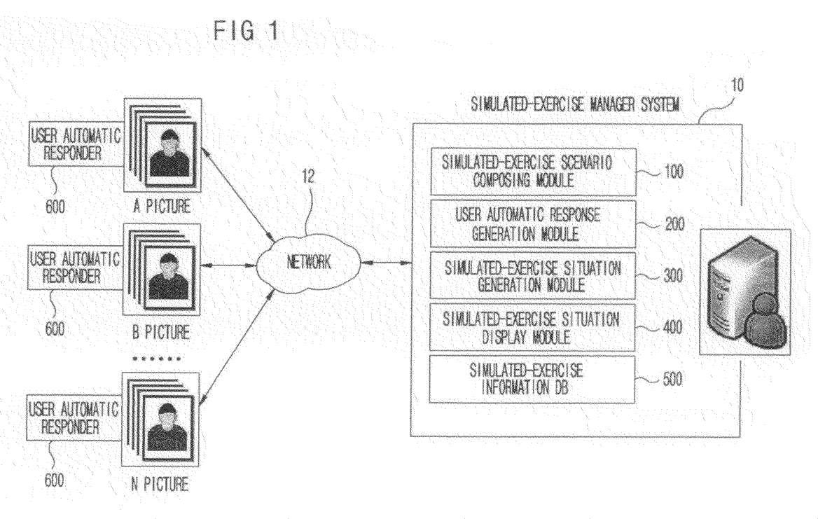

FIG. 1 is a block diagram illustrating a system for supporting simulated-exercise using a message according to an embodiment of the present invention.

Referring to FIG. 1, a simulated-exercise manager system 10 includes five modules. That is, the simulated-exercise manager system 10 includes a simulated-exercise scenario composing module 100, a user automatic response generation module 200, a simulated-exercise situation generation module 300, a simulated-exercise situation display module 400, and a simulated-exercise information database 500.

A simulated-exercise manager can train trainees, simulated-exercise users, in remote locations connected through a public network 12 such as Internet by transmitting a situation message for informing a critical situation and transmitting an automatic response message through the simulated-exercise manager system 10. The trainees can response for the messages transmitted from the simulated-exercise manager system 10 using the user automatic responder 60.

The simulated-exercise scenario composing module 100 receives a situation message created by a simulated-exercise manager and an auto response message corresponding to the situation message and recognizes the range of an exercise group selected by a user. The exercise group may be one user automatic responder 600 or a group assigning a plurality of user automatic responders 600. After selecting the group, a user group is classified. Then, the created situation message, the auto response message, the user group, and the user group classification information are transferred to the simulated-exercise situation display module. The transferred message is stored in the simulated-exercise database 500.

The user automatic response generation module 200 searches and collects previously generated situation messages from the simulated-exercise information database 500 or the simulated-exercise scenario composing module 100. Also, the user automatic response generation module 200 receives an automatic response message corresponding to a predetermined situation message from the simulated-exercise information database 500.

The user automatic response generation module 200 receives user automatic response information corresponding to a situation message, which is transmitted to a trainee through the network 12 and the user automatic responder 600, through the user automatic responder 600 and the network 12. The received user automatic response information is transmitted to the simulated-exercise situation display module 400. The user automatic response information includes a simulated-exercise situation message and a response message for automatic response message. The simulated-exercise situation generation module 300 checks user group information from the simulated-exercise information database 500 or the simulated-exercise scenario composing module 100, selects an exercise group according to the user group information, receives a situation message from the simulated-exercise information database 500, and transmits the received situation message to trainee through the network 12 and the user automatic responder 600. The simulated-exercise situation generation module 300 generates simulated-exercise generation information, which is information related to an exercise message, and provides the generated simulated-exercise generation information to the exercise situation displaying module 400 and the simulated-exercise database 500. The simulated-exercise generation information includes information about a group of users currently in a simulated-exercise, a situation message, and a state of transmitting a simulated-exercise message.

The simulated-exercise situation display module 400 displays a simulated-exercise situation message and automatic response message/group information (exercise group information). Also, the simulated-exercise situation display module 400 displays the simulated-exercise generation information received from the simulated-exercise situation generation module 300 and user automatic response information for indicating a current state of user automatic response if a response is received from a trainee through the network 12.

All of information for simulated-exercise is stored in the simulated-exercise information database 500. A current simulated-exercise can be evaluated based on a simulated-exercise analysis reference through the corresponding information stored in the simulated-exercise information database 500.

The user automatic responder 600 receives an exercise message having a situation message from the simulated-exercise situation generation module 300 and also receives an automatic response message. The received exercise message and automatic response message are transmitted to trainees by the selected group. If the user automatic responder 600 receives a user automatic response message from a trainee, the user automatic responder 600 transmits the received message to the user automatic response generation module 200 of the simulated-exercise manager system 10.

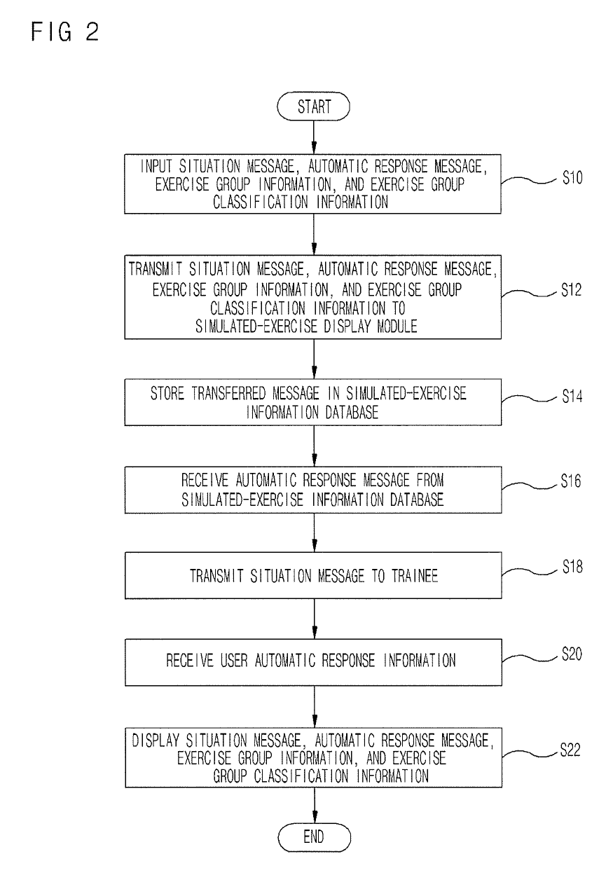

FIG. 2 is a flowchart illustrating a method for supporting a simulated-exercise using a message according to an embodiment of the present invention.

Referring to FIG. 2, the simulated-exercise scenario composing module 100 of the simulated-exercise manager system 10 receives a situation message composed by a simulated-exercise manager, an automatic response message corresponding to the situation message, user selected exercise group information, and exercise group classification information at step S10.

The exercise group information indicates a range of an exercise group selected by a user. The exercise group may be one user automatic responder 600 or a plurality of user automatic responders 600. At step S12, a situation message, an automatic response message, user group information, and user group classification information are transferred to the simulated-exercise situation display module 400. At step S14, the transferred messages are stored in the simulated-exercise database 500.

The user automatic response generation module 200 in the simulated-exercise manager system 10 searches previously generated situation messages from the simulated-exercise information database 500 or the simulated-exercise scenario composing module 100 and receives an automatic response message corresponding to a predetermined situation message from the simulated-exercise information database 500 at step S116.

The simulated-exercise situation generation module 300 of the simulated-exercise manager system 10 checks user group information from the simulated-exercise information database 500 or the simulated-exercise scenario composing module 100, selects an exercise group according to the user group information, receives a situation message corresponding to the selected exercise group from the simulated-exercise information database 500, and transmits the situation message to trainees through the network 12 and the user automatic responder 600 at step S18.

The user automatic response generation module 200 receives user automatic response information corresponding to a situation message, which is transmitted to a trainee through the network 12 and the user automatic responder 600, through the user automatic responder 600 and the network 12 at step S20.

The simulated-exercise situation display module 400 of the simulated-exercise manager system 10 displays the simulated-exercise situation message and the automatic response message/exercise group information, and user automatic response information, which are stored in the simulated-exercise information database 500 at step S22. The user automatic response information denotes a current state of a user automatic response.

All of information about the simulated-exercises is stored in the simulated-exercise information database 500, and a current simulated-exercise can be evaluated according to an analyzing reference of a simulated-exercise based on the corresponding information stored in the simulated-exercise information database 500.

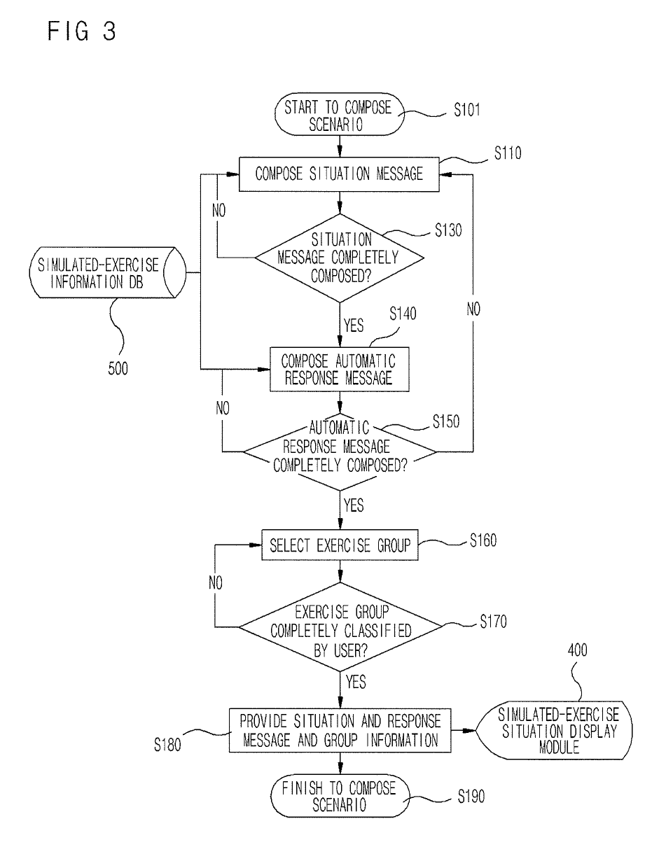

FIG. 3 is a flowchart illustrating the operations of a scenario composing module according to an embodiment of the present invention.

Referring to FIG. 3, the simulated-exercise scenario composing module 100 starts to operate at step S101 in response to a request of a simulated-exercise manager.

At step S10, a simulated-exercise manager composes a situation message through the simulated-exercise scenario composing module 100. At step S130, the simulated scenario composing module 100 determines whether the simulated-exercise manager finishes the creation of a situation message or not.

If the manager does not finish the creation of the situation message at step S130, the step S110 is performed again. If the manager finishes the creation of the situation message at step S130, the simulated-exercise scenario composing module 100 enables a simulated-exercise manager to compose an automatic response message corresponding to the composed situation message at step S140. The simulated-exercise manager composes an automatic response message for the situation message corresponding to the simulated-exercise scenario composing module 100.

The simulated-exercise scenario composing module 100 determines whether a simulated-exercise manager finishes the creation of the automatic response message or not at step S150.

If the simulated-exercise scenario composing module 100 determines that a simulated-exercise manager does not finish the creation of the automatic response message at step S150, the step S140 is performed again If the simulated-exercise scenario composing module 100 determines that a simulated-exercise manager finishes the creation of the automatic response message at step S150, the simulated-exercise scenario composing module 100 displays information about a user automatic responder 500 connected to the simulated-exercise manager system 10 through the network 12 and displays client information, that is, information about trainee's computer connected to the user automatic responder 600 in order to enable a trainee to select an exercise group for the situation message and the response message at step S160.

The simulated-exercise scenario composing module 100 classifies exercise group classification information that assigns characteristics to the selected exercise group by an exercise group at step S170. For example, a group A is defined as a group receiving a situation message a, and a group B is defined as a group receiving a situation message b.

After classifying the user exercise group, a corresponding situation message, a corresponding automatic response message, user group information, and user group classification information are transmitted to the simulated-exercise displaying module 400 at step S180, and the transferred messages are stored in the simulated-exercise database 500.

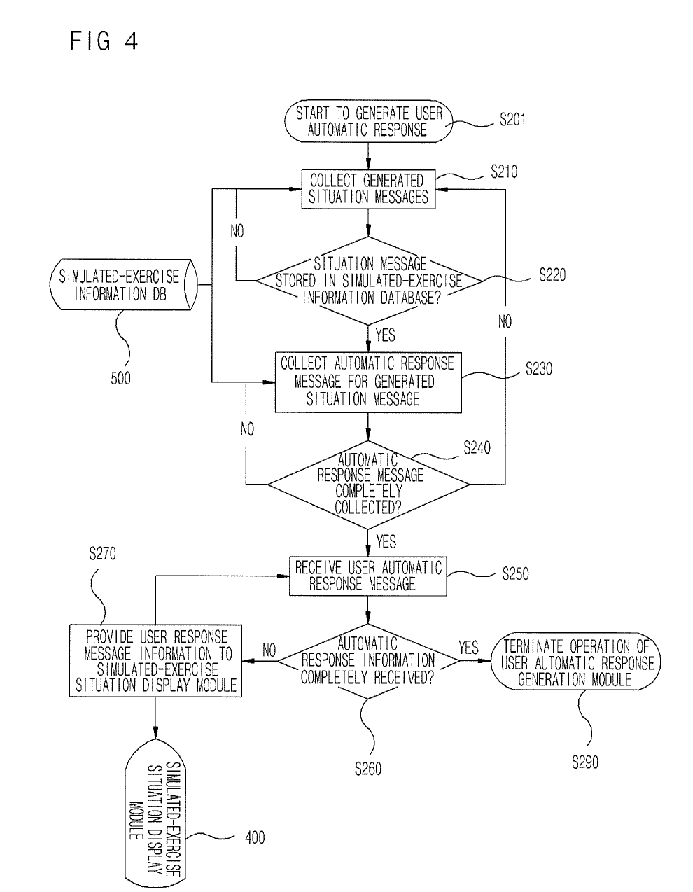

FIG. 4 is a flowchart illustrating the operations of a user automatic response generation module according to an embodiment of the present invention.

Referring to FIG. 4, the user automatic response generation module 200 starts to operate at step S201.

At step S210, the automatic response generation module 200 collects previously generated situation messages from the simulated-exercise information database 500.

At step S220, the user automatic response generation module 200 collects a situation message and determines whether a situation message is stored in the simulated-exercise information database 500 or not at step S220.

If the situation message is not stored in the simulated-exercise information database 500 at step S220, the step S210 is performed again. If the situation message is stored in the simulated-exercise information database 500 at step S220, the user automatic response generation module 200 collects an automatic response message corresponding to the generated situation message at step S230.

The user automatic response generation module 200 determines whether all of automatic response messages are received from the simulated-exercise information database 500 or not at step S240.

If the user automatic response generation module 200 determines that all of automatic response messages are not received from the simulated-exercise information database 500 at step S240, the step S240 is performed again. If the user automatic response generation module 200 determines that all of automatic response messages are received from the simulated-exercise information database 500 at step S240, a trainee receives inputted user automatic response information as a response corresponding to a situation message through the user automatic responder 600 and the network 12 at step S250.

At step S260, the user automatic response generation module 200 determines whether or not all of user automatic response information corresponding to the situation message and the automatic response message is received through the user automatic responder 600 and the network 12.

If the user automatic response generation module 200 determines that all of user automatic response information is not received from the trainee at step S260, the user automatic response generation module 200 transmits user automatic response information having situations received up to now to the simulated-exercise situation display module 400 in order to enable the simulated-exercise situation display module 400, and the step S260 is performed again.

If the user automatic response generation module 200 determines that all of user automatic response information is received from the trainee at step S260, the user automatic response information is stored in the simulated-exercise information database 500, and the operation of the automatic response generation module 200 is terminated at step s290 when all of the automatic response receiving messages are completely received.

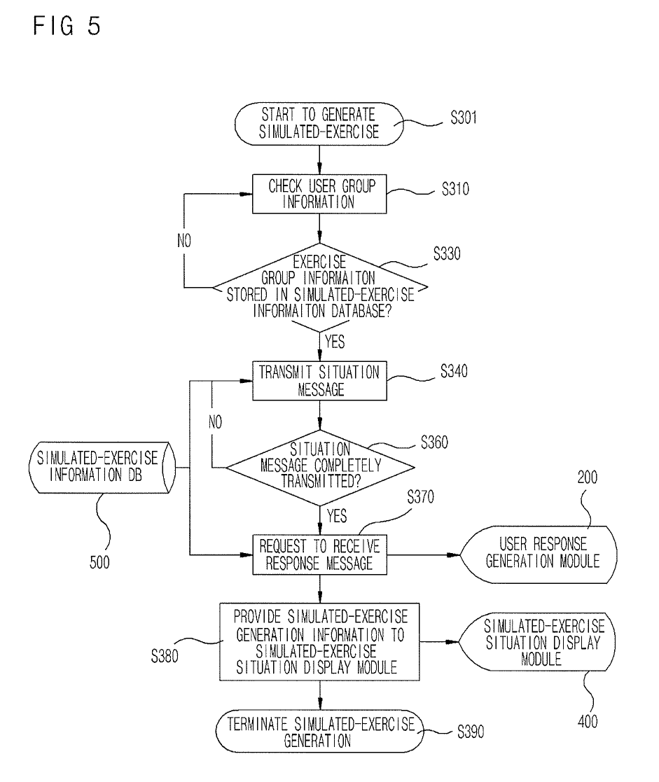

FIG. 5 is a flowchart illustrating the operations of a simulated-exercise situation generation module according to an embodiment of the present invention.

Referring to FIG. 5, the simulated-exercise situation generation module 300 starts to operate at step S301.

A simulated-exercise manager checks user group information for a simulated-exercise by searching the user group information from the simulated-exercise information database 500 through the simulated-exercise situation generation module 300 at step S310.

The simulated-exercise situation generation module 300 determines whether an exercise group is stored in the simulated-exercise information database 500 or not at step S330.

If the simulated-exercise situation generation module 300 determines that exercise group is not stored in the simulated-exercise information database 500 at step S330, the step S310 is performed again. If the simulated-exercise situation generation module 300 determines that exercise group is stored in the simulated-exercise information database 500 at step S330, an exercise group is selected according to exercise group information.

The simulated-exercise situation generation module 300 transmits a situation message stored in the simulated-exercise information database 500 to the selected exercise group through the network and the user automatic responder 600 at step S340.

The simulated-exercise situation generation module 300 determines whether the situation messages are completely transmitted to the user automatic responders 600 of the corresponding exercise group through the network 12 at step S360.

If the simulated-exercise situation generation module 300 determines that the situation messages are not completely transmitted to the user automatic responders 600 of the corresponding exercise group through the network 12 at step S360, the step S340 is performed again. If the simulated-exercise situation generation module 300 determines that the situation messages are completely transmitted to the user automatic responders 600 of the corresponding exercise group through the network 12 at step S360, the simulated-exercise situation generation module 300 requests the user automatic response generation module 200 to receive an auto response in order to receive an automatic response message from a user at step S370.

The simulated-exercise situation generation module 300 provides simulated-exercise generation information to the simulated-exercise situation display module 400 at step S380.

Also, the simulated-exercise generation information generated by the simulated-exercise generation module 300 and the user automatic response information generated by a user response are stored in the simulated-exercise information database 500 in order to enable the simulated-exercise scenario composing module 100, the user automatic response generation module 200, the simulated-exercise situation generation module 300, and the simulated-exercise situation display module 400 to share the information.

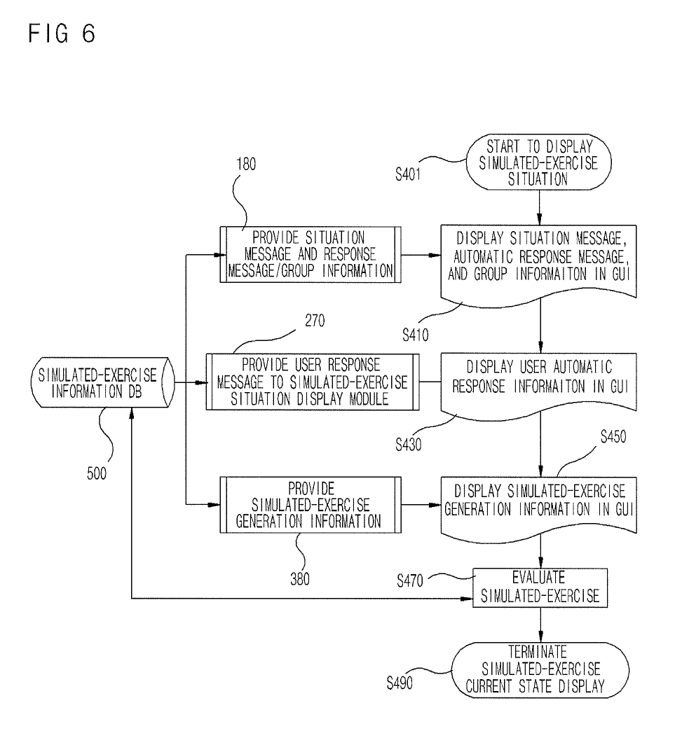

FIG. 6 is a flowchart illustrating the operations of a simulated-exercise situation display module according to an embodiment of the present invention.

Referring to FIG. 6, the simulated-exercise situation display module 400 starts to display simulated-exercise situation at step S401.

The simulated-exercise situation display module 400 receives a situation message, an auto response message, and group information such as user group information and user classification information and displays the received information in GUI formation at step S410.

Also, the simulated-exercise situation display module 400 displays user automatic response information received from the user automatic response generation module 200 or the simulated-exercise information database 500 in a GUI formation at step S430.

Furthermore, the simulated-exercise situation display module 400 displays the simulated-exercise generation information received from the simulated-exercise situation generation module 300 or the simulated-exercise information database 500 in a GUI formation at step S450.

Entire information about the simulated-exercise is stored in the simulated-exercise information database 500, and the simulated-exercise is evaluated based on a simulated-exercise analysis reference through the infornationi stored in the simulated-exercise information database 500 at step S470.

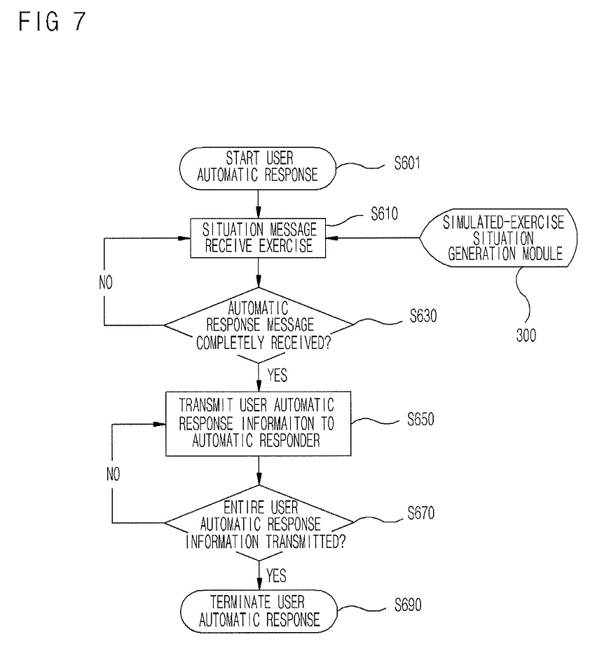

FIG. 7 is a flowchart illustrating the operations of a user automatic responder according to an embodiment of the present invention.

Referring to FIG. 7, the user automatic responder 600 receives an exercise situation message having critical situation information from the simulated-exercise situation generation module 300 through a network at step S610.

The user automatic responder 600 receives an automatic response message corresponding to an exercise situation message from the simulated-exercise information database 500 and determines whether the corresponding automatic response message is completely received or not at step S630.

If the corresponding automatic response message is not completely received at step S630, the step S610 is performed again. If the corresponding automatic response message is completely received at step S630, the user automatic responder 600 transmits the simulated-exercise situation message and the automatic response message to the trainee, and if a message inquiry for the simulated-exercise situation message and the automatic is completed, the trainee transmits user automatic response information according to a corresponding inquiry at step S650.

The user automatic responder 600 determines whether the user automatic response information inputted from the trainee is completely transmitted to the simulated-exercise manager system 20, particularly, to the user automatic response generation module 200 at step S670.

If the user automatic responder 600 determines that the user automatic response information inputted from the trainee is not completely transmitted to the simulated-exercise manager system 20 at the step S670, the step S650 is performed again. If the user automatic responder 600 determines that the user automatic response information inputted from the trainee is completely transmitted to the simulated-exercise manager system 20 at the step S670, the user automatic responder 600 determines that the user automatic response information is successfully returned and terminates the user automatic response function at step S690.

As described above, the simulated-exercise system according to the present invention can evaluate the appropriateness of user countermeasure by setting up an imaginary critical situation in a message. Although a conventional exercise technology assumes an imaginary event is performed, the simulated-exercise system according to the present invention can detect the current states of an exercise through creating, distributing, and evaluating messages used in a simulated exercise. Therefore, the simulated-exercise system according to the present invention can provide better exercise result.

It will be apparent to those skilled in the art that various modifications and variations can be made in the present invention. Thus, it is intended that the present invention covers the modifications and variations of this invention provided they come within the scope of the appended claims and their equivalents.

What is claimed is:

1. A system for supporting a simulated-exercise using a massage, comprising a simulated-exercise manager system for training trainees in a remote location connected through a network by transmitting a situation message for informing critical situations to the trainees and an automatic response message.

2. The system of claim 1, wherein the simulated-exercise manager system includes:
a simulated-exercise scenario composing module for receiving a created situation message and an automatic response message corresponding the created situation message, and sequentially receiving information about an exercise group selected by a user and information about exercise group classification;
a user automatic response generation module for receiving user automatic response information inputted from a trainee by receiving the situation message and the automatic response message corresponding to the situation message;
a simulated-exercise situation generation module for confirming user group information, selecting an exercise group according to the user group information, receiving a situation message created corresponding to the selected exercise group, transmitting a situation message to a user automatic responder, and generating simulated-exercise generation information;
a simulated-exercise information database for storing a simulated-exercise situation message, an automatic response message/group information, user automatic response information, and simulated-exercise generation information; and
a simulated-exercise situation display module for displaying a simulated-exercise situation message, automatic response message/group information, user automatic response information, and simulated-exercise generation information.

3. A method for supporting a simulated-exercise using a situation message, an automatic response message corresponding to the situation message, and a message for receiving information about an exercise group selected by a user and exercise group classification information, and processing the message at a simulated-exercise scenario composing module in a simulated-exercise manager system, comprising the steps of:
a) storing a situation message, an auto response message, user group information, and user group classification information in a simulated-exercise database;
b) at a user automatic response generation module in the simulated-exercise manager system, searching the situation message from the simulated-exercise information database and receiving an automatic response message corresponding to the situation message;
c) at a simulated-exercise situation generation module in the simulated-exercise manager system, receiving a situation message from the simulated-exercise information database and transmitting the received situation message to a trainee;
d) receiving automatic response information corresponding to the transmitted situation message from a trainee; and
e) at a simulated-exercise situation display module of the simulated-exercise manager system, displaying a simulated-exercise situation message, an automatic response message, exercise group information, and user automatic response information, which are stored in the simulated-exercise information database.

4. The method of claim 3, wherein the exercise group information is information about one user automatic responder or a group assigning a plurality of user automatic responders.

5. The method of claim 3, wherein the step a) includes the steps of:
transmitting the situation message, the automatic response message corresponding the situation message, the user group information, and the user group classification information to the simulated-exercise situation display module; and
storing the situation message, the automatic response message corresponding the situation message, the user group information, and the user group classification information at the simulated-exercise database.

6. The method of claim 3, wherein the step c) includes the steps of:
at the simulated-exercise situation generation module, determining whether or not user group information is included in the simulated-exercise information database for generating a simulated-exercise;
selecting an exercise group according to exercise group information if the simulated-exercise situation generation module determines that the exercise group information is included in the simulated-exercise information database;
at the simulated-exercise situation generation module, transmitting a situation message in the simulated-exercise information database to the exercise group selected through the user automatic responder;
at the simulated-exercise situation generation module, providing simulated-exercise generation information to the simulated-exercise situation display module; and
at the simulated-exercise situation generation module, storing simulated-exercise generation information in a database.

7. The method of claim 3, further comprising the steps of:
at the simulated-exercise situation display module, receiving and displaying a situation message, an automatic response message, and group information from a simulated-exercise scenario composing module;
at the simulated-exercise situation display module, receiving and displaying user automatic response information from the user automatic response generation module; and
at the simulated-exercise situation display module, receiving and displaying simulated-exercise generation information from the simulated-exercise situation generation module.

8. The method of claim 3, further comprising the step of: receiving the situation message, the automatic response message, the group information, the user automatic response information, and simulated-exercise generation information from the simulated-exercise information database, storing the received messages and information, and evaluating a simulated-exercise according to a simulated-exercise analysis reference through the corresponding information.

9. The method of claim 3, further comprising the steps of, after the step c):
at the user automatic responder, receiving a exercise situation message having critical situation information from the simulated-exercise manager system through a network;
at the user automatic responder, transmitting a simulated-exercise situation message and an automatic response message to a trainee, and receiving user automatic response information as a response of the automatic response message; and
at the user automatic responder, transmitting the received user automatic response information to the simulated-exercise manager system.
